(19) United States
(12) Patent Application Publication
(10) Pub. No.: US 2004/0090017 A1
(43) Pub. Date: May 13, 2004

(54) Universal physical barrier

(76) Inventors: Steven Roberts, Sterling Heights, MI (US); Pero Ljubevski, Canton, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/290,892

(22) Filed: Nov. 8, 2002

(51) Int. Cl. F16J 15/46

(52) U.S. Cl. 277/628

(57) ABSTRACT

The present invention relates a multi-plane physical barrier that can be used to fill an orifice, hole or cavity. The barrier includes two or more relatively rigid carriers that are connected to one another by a “hinge.” The “hinge” may take a variety of forms.

### FIELD OF THE INVENTION

This invention relates to a multi-plane physical barrier for sealing orifices and cavities.

### BACKGROUND OF THE INVENTION

Physical barriers are commonly used to seal orifices in certain objects, such as panel members in motor vehicles, buildings, household appliances, etc. These barriers normally are used to prevent physical materials, fluids, and gases, such as environmental contaminants, fumes, dirt, dust, moisture, water, etc., from passing through the orifice or cavity. For example, an automotive panel, such as a door panel, typically has several small orifices in the sheet metal, which are created for various reasons during manufacturing. Further, various structural components of automobile bodies have a variety of orifices, hollow posts, cavities, passages and openings that can allow contaminants from the engine and the roadway into the passenger compartment. These holes, orifices, and cavities are typically barricaded with duct tape, butyl-based plastic patches, and sealing plugs made from foam, rubber or some other material. Another known physical barrier for cavities involves introducing a foam product into the cavity, and using a fiberglass matting to fill in the cavity.

One known type of physical barrier is comprised of a sealer material disposed on a carrier device. The carrier device is generally manufactured from a rigid material, such as hard plastic, such that its shape approximates the shape of the orifice to be sealed. The carrier/sealer combination is configured such that the carrier is inserted into/onto an orifice, and the sealer material creates an airtight seal between the carrier and the edges of the orifice. Typically, the sealer material is activated (thermally or chemically) shortly before or after insertion into the orifice so that the sealer material forms a seal around the edges of the orifice.

Orifices and cavities that require sealing come in a variety of shapes and sizes. Some orifices, such as holes in a piece of sheet metal, are essentially planar (two-dimensional). For these types of two-dimensional orifices, a simple planar carrier can be used to fill the orifice. On the other hand, some orifices, such as certain cavities or orifices that extend around sheet metal comers, for example, are three-dimensional in nature. Three-dimensional orifices or cavities can be sealed by using two or more planar carriers. Moreover, it is also known to use a single multi-planar physical barrier, wherein the carrier is molded into a relatively rigid multi-planar shape so as to match the shape of the orifice.

While rigid multi-planar barriers can be effective for sealing three-dimensional orifices and cavities, they are relatively difficult and costly to manufacture and stock. For instance, because the same shaped orifice may be present in different places on a product (such as a vehicle), many multi-plane barriers require both a “right-hand” and a “left-hand” version. As a result, each multi-plane barrier shape requires two different molds and other tooling for manufacturing. This orientation issue is particularly problematic in the automotive industry because cars inherently have a right and left side. Thus, the cost of every aspect of multi-plane barrier manufacturing is twice that of comparable single-plane barrier. Further, relatively complex manufacturing processes are required to manufacture rigid multi-planar carriers. Finally, increased costs resulting from stocking two versions of each multi-planar barrier and increased costs from having two versions of each shipping package for each multi-planar barrier are both undesirable consequences of multi-planar barriers.

Consequently, the inventors have recognized the need for multi-planar physical barriers that are quicker, easier and more economical to manufacture, as well as being more economical to package, ship and install.

### BRIEF DESCRIPTION OF THE DRAWINGS

In the drawings:

FIG. 1 shows a cut away view of a physical barrier in a multi-plane configuration installed in a panel member according to an embodiment of the invention.

FIG. 2 shows a perspective view of a carrier in a multi-plane configuration according to an embodiment of the invention.

FIG. 3 shows a perspective view of a physical barrier in a multi-plane configuration according to an embodiment of the invention.

FIG. 4 shows a perspective view of a carrier in a single-plane configuration according to an embodiment of the invention.

FIG. 5 shows an end view of a carrier in a multi-plane configuration according to an embodiment of the invention.

### DETAILED DESCRIPTION

The present invention includes a three-dimensional or multi-plane physical barrier that is capable of being manufactured, packaged and shipped as a single-plane physical barrier and that is “universal” or “orientation independent.” In effect, the inventive barrier comprises two or more relatively rigid single-plane carriers that are flexibly connected together at their respective edges by a “hinge.” In this way, the inventive barrier can be manufactured, shipped and stored as a single-plane barrier, and, at the time of installation, it can be “opened” into a multi-plane barrier. Because of the flexible connection, the same multi-plane barrier of the inventive design can be given either a right-handed or a left-handed orientation, depending on the requirements of the orifice to be sealed.

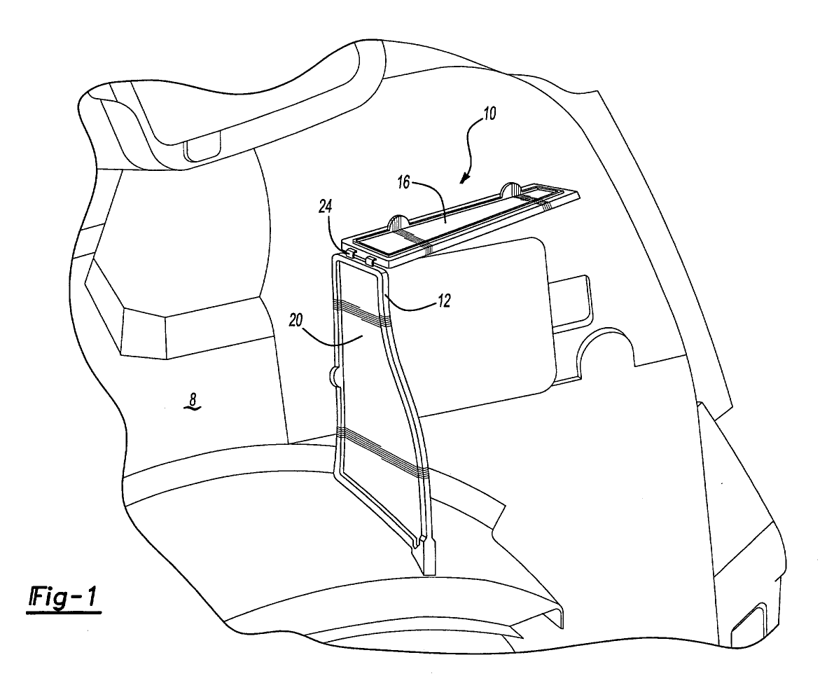

FIG. 1 shows a panel member 8, which, together with another panel member (not shown), creates a cavity in an automobile structural component. In this example, the cavity is located in the fender of the automobile. In order to prevent water, dirt, noise and other contaminants from entering the automobile through the fender, it is desirable to block the cavity. A physical barrier is used to block and seal the cavity, thereby creating a protected area of the cavity where water, dirt, etc. cannot enter. As seen in FIG. 1, a multi-plane physical barrier 10 includes a first carrier 16, a second carrier 20, and a sealer material 12 disposed thereon. The first carrier 16 is flexibly connected to the second carrier 20 by a hinge 24 such that first carrier 16 and second carrier 20 can be rotated relative to each other. The multi-plane physical barrier 10 is configured to be applied to the cavity formed in the panel member 8 by adjusting the relative positioning of first carrier 16 and second carrier 20. In this way, the barrier 10 can be made to be flat (i.e., essentially planar) for purposes of packaging, shipping, and storing, and the barrier 10 can be converted into a multi-plane barrier for installation. Further, because the hinge 24 allows the physical barrier to be given either a right or left-handed orientation, the need to manufacture both right-handed and left-handed versions of the same multi-plane barrier is eliminated.

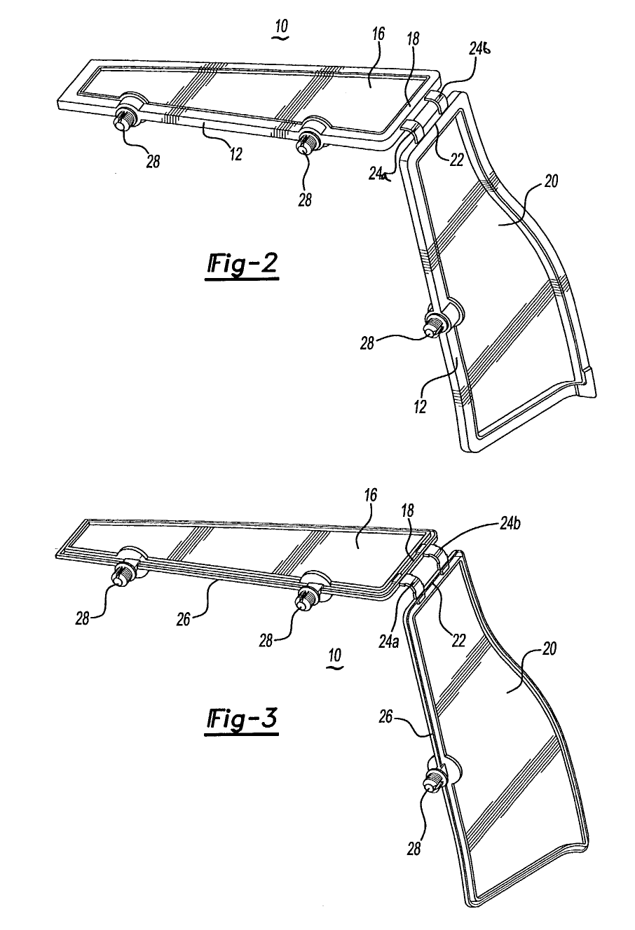

FIG. 2 illustrates a more detailed view of the inventive multi-plane physical barrier 10. The physical barrier 10 includes first and second carriers 16 and 20 connected together at their respective joined edges 18 and 22 by hinge 24. Optional securing pins 28 are positioned around the outer edges of the first and second carriers 16 and 20 to secure the barrier 10 into the orifice or cavity upon installation. A sealer material 12 is preferably disposed around the outer circumference of each of the carriers 16 and 20. FIG. 3 illustrates an embodiment of the invention that is the same as that illustrated in FIG. 2, except that FIG. 3 shows an embodiment that does not include sealer material 12.

When used, the sealer material 12 may be any known sealing material, but preferably is one that expands upon activation (e.g., thermal or chemical activation), although non-expanding sealer materials are also suitable. One useful type of expandable material is a heat-activated foam. While a heat activated foam is preferred, it is to be understood that the invention may be practiced with other types of foams that are, for example, chemically activated. Preferred sealer materials include those described in U.S. Pat. Nos. 5,266,133, 6,150,428, 6,368,438 and 6,387,470, whose disclosures are incorporated by reference herein. Though the sealer 12 is shown in FIG. 2 as being disposed on the outer edges of carriers 16 and 20, the sealer material 12 may be placed on the carriers in any known manner.

The individual planar carriers 16 and 20 of the inventive barrier 10 generally have a size and shape that is dictated by the size and shape of the cavity or orifice into which the barrier is to be inserted. The carriers 16 and 20 may be made from a variety of conventional materials, though it is preferable that the carrier material be resistant to the means of activating the sealer material. For example, it is desirable that the carrier material have a relatively high melt temperature if used in conjunction with a sealer material that is heat-activated. While metals may be used for the carriers and hinges, plastics are preferred because of the reduced weight and reduced amount of force needed to install a plastic carrier as compared to a metal carrier. One useful plastic material is nylon.

Hinge 24 is preferably configured so as to allow planar carriers 16 and 20 to rotate relative to each other. Accordingly, the hinge 24 should have a certain degree of flexibility. Further, the hinge 24 is preferably reversibly actuatable; that is, when pressure is applied to the carriers 16 and 20, the hinge 24 actuates, and when the pressure is released, the hinge 24 returns to its original position. “Actuate-and-hold” hinges—hinges that do not return to their original position when the applied pressure is released—may also suitable. Like the carriers 16 and 20, the hinge 24 should be made from a material that is resistant to the means of activating the sealer material 12.

The particular hinge 24 illustrated in FIGS. 2 and 3 comprises relatively thin strips of flexible material 24a and 24b. If the hinge strips 24a and 24b are made from the same material as the carriers, then the hinge strips should be of a thinner profile than the carriers to provide the desired flexibility in the hinge. Alternatively, the hinge strips may be of the same material and thickness as the carriers 16 and 20, but lack certain rigidity enhancing elements present in/on the carriers 16 and 20, such as thick rigid beads disposed on one side of the carriers. The hinge strips 24a and 24b in FIGS. 2 and 3 are shown as being separate components that are connected and secured between carriers 16 and 20 by tabs that snap into holes in the carriers. However, the hinge strips could also be integrally formed with the carriers 16 and 20 during manufacture, thereby eliminating the need for any particular connection means. Moreover, the hinge strips 24a and 24b may actually be a single hinge strip that runs the entire length of the interface between edges 18 and 22. In light of the disclosure, one skilled in the art will recognize many variations of the hinge 24 that can be used in the inventive barrier.

In addition to that shown in FIGS. 2 and 3, the hinge 24 may take a variety of forms and operate in different ways, provided that it permits the carriers 16 and 20 to rotate relative to each other. For example, in addition to the flexible “bending” type of hinge shown in FIGS. 2 and 3, the hinge may be a common “rotating” hinge (as used on most doors) or a “ball and socket” hinge. Moreover, the hinge 24 may be manufactured as a separate component from the carriers 16 and 20, or it may be manufactured integral or partially integral to the carriers 16 and 20. When manufactured as a separate component, hinge 24 may be connected to the separate carriers 16 and 20 via any suitable connection method, including fasteners and adhesives. When manufactured integral to the carriers 16 and 20, the hinge 24 and the carriers can be created from a single mold. When manufactured partially integral to the carriers 16 and 20—for example, a “ball and socket” type hinge—one carrier 16 can be manufactured integral with one portion of the hinge (e.g., the “ball”) and the other carrier 20 can be manufactured integral with the other portion of the hinge (e.g., the “socket”). When assembled, the “ball” and “socket” of the respective carriers function together to form a hinge.

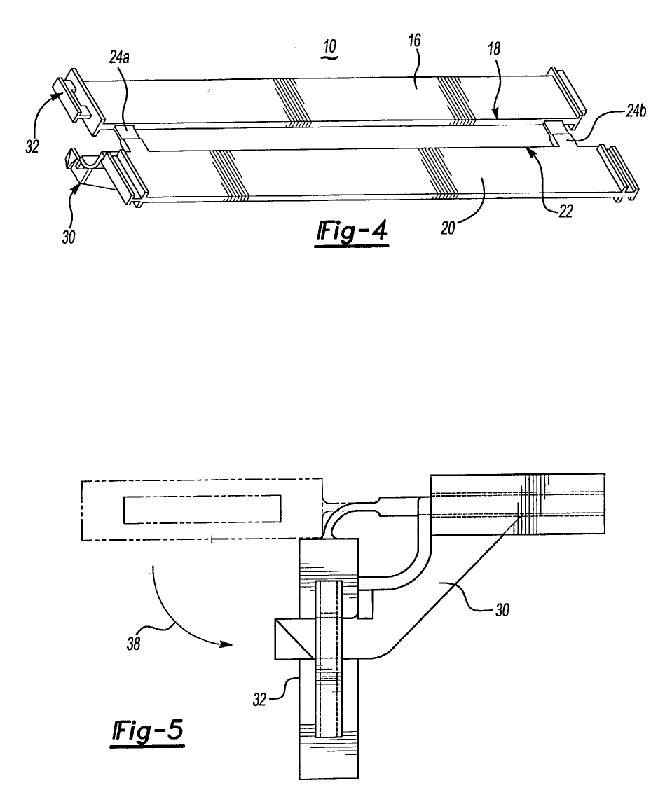

FIG. 4 illustrates another embodiment of the invention, which discloses some additional variations and optional features of the inventive barrier. Components in FIG. 4 that are similar to components in FIGS. 2 and 3 bear the same reference numerals. In the embodiment shown in FIG. 4, the carriers 16 and 20 are connected by hinge 24, which, as in the embodiment shown in FIGS. 2 and 3, comprises two hinge strips 24a and 24b. Unlike FIGS. 2 and 3, though, the embodiment of FIG. 4 includes components used to “lock” the two planar carriers 16 and 20 in place relative to each other during installation. This feature is desirable in certain applications, particularly where the adhering tendency of the unactivated sealer material 12, if used, is not sufficient to maintain the barrier in place against the spring force of the hinge 24. The “locking” feature of FIG. 4 can be accomplished by the combination of a male locking member 30 and a female locking member 32, which are configured to engage each other to maintain the relative positioning of the planar carriers 16 and 20. In FIG. 4, the male and female locking members 30 and 32 establish a “snap lock” when the male locking member 30 is inserted into the female locking member 32.

FIG. 5 illustrates an end view of the embodiment of the barrier shown in FIG. 4 to illustrate the “locking” feature described above. When the carriers 16 and 20 are rotated toward each other (shown by arrow 38), the male locking member 30 is inserted into the female locking member 32. The engagement of the two locking members 30 and 32 holds the two carriers 16 and 20 in place relative to each other, even though the hinge 24 is reversibly actuatable.

The application of the inventive physical barrier 10 will now be described. As indicated, the physical barrier 10 can be manufactured in a variety of ways, including wherein the carriers 16 and 20 and the hinge 24 are all integral, or wherein the carriers 16 and 20 are separate components from the hinge 24. For example, barrier 10 can be manufactured using a single mold wherein carriers 16 and 20 are aligned in a co-planar fashion during manufacture. In any event, it is preferable that the barrier 10 be manufactured such that it can be easily stored in a flat configuration (as shown in FIG. 4) so that it is approximately planar. A planar orientation of the barrier 10 makes the packaging and shipping tasks easier. The sealer material 12, if used, may be applied to the carriers 16 and 20 either before or after the barrier 10 is shipped to the end user. If the sealing material is applied to the carriers prior to shipping, the installation process is simplified.

The end user installs the barrier 10. First, the user adjusts the relative positions of the carriers 16 and 20 so as to match the shape of the three-dimensional space of the orifice or cavity to seal. Actuating the hinge 24 in one direction forms a multi-plane barrier with one orientation (e.g., “right-handed” orientation), whereas actuating the hinge 24 in the other direction forms a multi-plane barrier with the opposition orientation (e.g., “left-hand” orientation). If used, a locking device can maintain the relative position of the carriers after being set. Then, the barrier 10 is applied to or on an orifice or cavity. The barrier 10 can be maintained in position relative to the orifice or cavity by friction, by the sealing material 12, or by securing pins 28 (FIGS. 2 and 3). The carriers 16 and 20 block most of the open space of the orifice or cavity, and any additional space, particularly around the edges of the carriers 16 and 20, including any gap near the hinge 24, is filled by the sealing material 12 after it is activated. After being activated, the sealing material 12 permanently holds the barrier 10 in place relative to the orifice or cavity.

Many variations of the illustrated preferred embodiments are contemplated to be included in the scope of the present invention. For example, while specifically shown with only two carriers, one skilled in the art will recognize that a barrier with any number of carriers may be utilized to form barriers having any number of planes. Further, while certain of the advantages of the invention are realized best if the carriers are flat, multi-dimensional carriers may also be connected together by a hinge and remain within the scope of this invention.

While the invention has been specifically described in connection with certain specific embodiments thereof, it is to be understood that this is by way of illustration and not of limitation, and the scope of the appended claims should be construed as broadly as the prior art will permit.

What is claimed is:

1. A physical barrier comprising:
a first carrier adapted to be applied to an opening in a panel member;
a second carrier adapted to be applied to an opening in a panel member; and
a hinge connecting said first and second carriers.

2. The physical barrier of claim 1, further comprising a sealer material disposed on at least one of said first and second carriers.

3. The physical barrier of claim 1, wherein said carriers are co-planar relative to each other at the time of manufacture.

4. The physical barrier of claim 1, wherein said hinge is integral to said first and second carriers.

5. The physical barrier of claim 1, wherein said hinge is made of the same material as said first and second carriers.

6. The physical barrier of claim 1, wherein said hinge has a thickness less than a thickness of said first and second carriers.

7. The physical barrier of claim 1, wherein said hinge includes a securing tab.

8. The physical barrier of claim 1, wherein said hinge is a bending hinge.

9. The physical barrier of claim 8, wherein said bending hinge comprises at least one flexible hinge strip that connects said first and second carriers.

10. The physical barrier of claim 1, wherein said hinge is a ball and socket hinge.

11. The physical barrier of claim 1, wherein said hinge is a twisting hinge.

12. The physical barrier of claim 1, wherein said hinge is a reversibly actuatable hinge.

13. The physical barrier of claim 1, further including a locking device configured to secure the respective positions of said first and second carriers relative to each other.

14. A method for installing a multi-plane physical barrier having a first carrier and a second carrier, comprising:
moving the first carrier relative to the second carrier about a connecting hinge; and
applying said barrier to an orifice.

15. The method of claim 14, further comprising:
activating an expandable sealer material disposed on the first and second carriers.

16. A method of manufacturing a physical barrier, comprising:
providing a substantially flat first carrier and a substantially flat second carrier; and
connecting said first and second carriers with a hinge,
wherein said first and second carriers are capable of being positioned such that the carriers are co-planar relative to each other.

17. The method of claim 16, wherein said providing step and said connecting step occur substantially simultaneously.

18. The method of claim 16, wherein said providing step includes molding the first and second carriers.

19. The method of claim 16, further comprising:
providing a sealer material disposed on the first carrier and on the second carrier.
